(19) United States
(12) Patent Application Publication
(10) Pub. No.: US 2005/0236833 A1
(43) Pub. Date: Oct. 27, 2005

(54) Tube lock quick connector

(76) Inventors: David M. Poirier, Fort Gratiot, MI (US); Richard M. Pepe, Macomb, MI (US)

Correspondence Address: JENNER & BLOCK, LLP, ONE IBM PLAZA, CHICAGO, IL, 60611, US

(21) Appl. No.: 10/830,689

(22) Filed: Apr. 23, 2004

(51) Int. Cl. F16L 35/00

(52) U.S. Cl. 285/305

(57) ABSTRACT

A quick connector coupling for forming a joint in a fluid/vapor line system. The coupling comprises a female housing, a connector body, a male member and a retainer. The female housing has a bore extending from an end of the female housing and a radially enlarged section. The connector body has slots formed therethrough and a through bore extending from an end of the connector body. A portion of the connector body is located radially outward of said radially enlarged section of the female housing. The male member extends through the ends of the connector body and female housing and into the female housing bore. The male member has a tubular surface and an annular upset. The upset has a diameter greater than the diameter of the tubular surface. The retainer is coupled to the connector body. The retainer includes a cross member and two spaced legs extending from the cross member and through the slots. The legs are in abutting relationship with the male member upset. The legs are in a locked position in which the legs are spaced apart a distance less than the diameter of the upset.

### BACKGROUND OF THE INVENTION

This invention relates to fluid/vapor line systems which include quick connector couplings, and more particularly to a quick connector coupling having a secondary latch/verifier.

In automotive and other fields, quick connector couplings, which generally include a male member received and sealingly retained in a female connector body, are often utilized to provide a fluid connection between two components or conduits, thus establishing a fluid line between the two components. Use of quick connector couplings is advantageous in that a sealed and secured fluid line may be established with a minimum amount of time and expense.

A number of methods and mechanisms exist for securing the male member and female connector body of a quick connector coupling together. One type of retention mechanism involves the use of a retainer disposed within the connector body. The retainer has load-bearing members extending between a radial face formed within the connector body and an enlarged upset formed on the male member, thereby securing the male member within the connector body. One drawback of this type of retainer is that separation of the coupling is usually difficult to attain. A special release tool or sleeve is often required to disconnect the joint.

Another type of retention mechanism involves use of a retainer in the form of a retention clip inserted through slots formed in the exterior of the connector body. Beams extending through the slots are poised between the male member upset and the rearward surfaces defining the slots, thereby preventing disconnection of the coupling. Due to the physical appearance of such retainers, they are referred to in the trade as “horseshoe” retainers. An example of this type of retainer is found in U.S. Pat. No. 5,586,792, to Kalahasthy et al., which is herein incorporated by reference. The “horseshoe” retainer, disclosed in the '792 Patent, permits easy release of the coupling without significantly increasing the complexity of the coupling. The quick connector coupling of the present invention is an improvement of the type of coupling disclosed in the '792 Patent by using a connector body separate from a female housing formed at the end of a tube.

### BRIEF DESCRIPTION OF THE DRAWINGS

FIG. 1 is an exploded view of a quick connector coupling according to the present invention;

FIG. 2 is a perspective view of the connector body of FIG. 1;

FIG. 3 is a rear view of the connector body of FIG. 2;

FIG. 4 is a side view of the connector body of FIG. 2;

FIG. 5 is a sectional view of the connector body of FIG. 4, taken through line 5-5;

FIG. 6 is a sectional view of the connector body of FIG. 3, taken through line 6-6;

FIG. 7 is a perspective view of the primary retainer of FIG. 1;

FIG. 8 is a front view of the primary retainer of FIG. 7;

FIG. 9 is a side view of the primary retainer of FIG. 7;

FIG. 10 is a rear view of the primary retainer of FIG. 7;

FIG. 11 is a perspective view of the secondary latch/verifier of FIG. 1;

FIG. 12 is a top view of the secondary latch/verifier of FIG. 11;

FIG. 13 is a rear view of the secondary latch/verifier of FIG. 11;

FIG. 14 is a side view of the secondary latch/verifier of FIG. 11;

FIG. 15 is a sectional view of the female housing of FIG. 1 with the sealing members and the male member installed therein;

FIG. 16 is a side view of the coupling of FIG. 1, with the primary retainer in the locked position and the secondary latch/verifier in the latched positioned;

FIG. 17 is a sectional view of the coupling of FIG. 16, taken through line 17-17;

FIG. 18 is a sectional view of the coupling of FIG. 1, with the primary retainer in the released position and the secondary latch/verifier in the unlatched position.

### DETAILED DESCRIPTION OF THE DRAWINGS

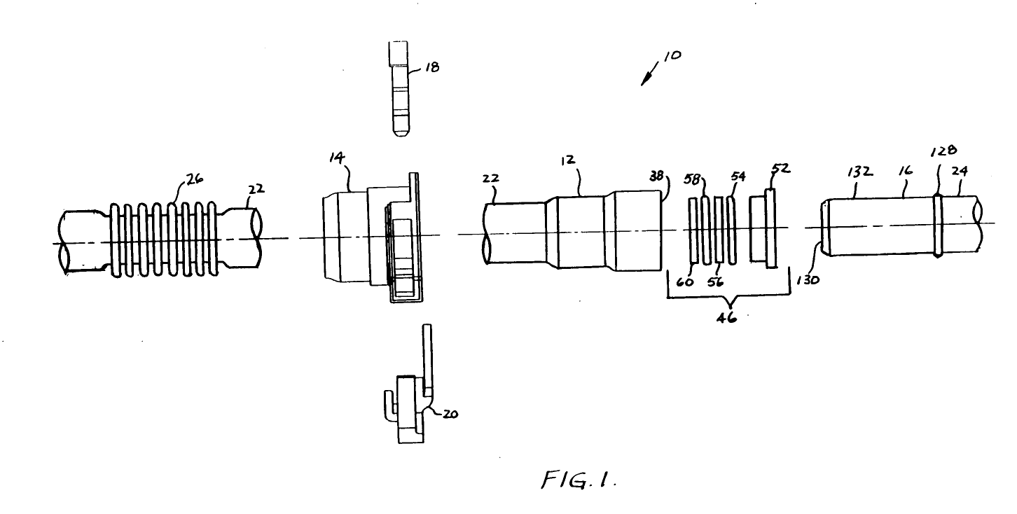

FIG. 1 illustrates a quick connector coupling 10 formed in a fluid/vapor line, such as a fuel filler inlet assembly. The coupling 10 is comprised of a female housing 12 preferably formed from a metallic material, a connector body 14 preferably formed from a polymeric material and a male member 16 preferably formed from a metallic material secured together by a polymeric primary retainer 18 and a polymeric secondary latch/verifier 20. The female housing is formed at an end of a first metallic hollow tube 22 which forms a part of a fluid line system. The male member 14 is formed at an end of a second hollow metallic tube 24 which is also a part of the fluid line system. The female housing 12 and the male member 16 are connectable to form a permanent, but severable, joint in the fluid and vapor line.

As illustrated in FIG. 1, the female housing 12 is formed at the end of the first tube 22. The first tube 22 and hence the female housing 12 is preferably formed from a metallic material, although the first tube 22 and the female housing 12 can also be formed from a polymeric material. The first tube 22 is preferably attached to an omega shape flexible member 26. The flexible member 26 allows the female housing 12 to be more easily aligned with the male member 16. The female housing 12 is illustrated in detail in FIG. 15. The female housing 12 is defined by a generally cylindrical, stepped exterior wall 30 and a generally cylindrical, stepped interior wall 32. The interior wall 32 defines a bore 36. The bore 36 extends completely through the female housing 12, from a larger diameter entrance 38 to a smaller diameter non-expanded portion of the first tube 22. The female housing 12 and the bore 36 are centered about an axis 34.

Variations in the diameter of the interior wall 32 of the female housing 12 divide the bore 36 into three distinct sections, as illustrated in FIG. 15. Moving axially inward from the entrance 38 to the non-expanded portion of the first tube 22, they are: seal chamber 40, tube end receptacle 42, and fluid passageway 44.

The seal chamber 40 is adjacent to the entrance 38. The seal chamber 40 is provided to house sealing elements 46 to form a fluid/vapor seal between the female housing 12 and the male member 16. The tube end receptacle 42 is located axially inward of the seal chamber 40. The tube end receptacle 42 is defined by a reduced diameter portion of the interior wall 32, relative to seal chamber 40, which extends axially inward from a first conical shoulder 48 to a second conical shoulder 50. The tube end receptacle 42 is provided to receive an open end of the male member 16.

As illustrated in FIGS. 1 and 15, the sealing elements 46 include a top spacer 52, a first sealing member 54, a mid spacer 56, a second sealing member 58, and a bottom spacer 60. The top spacer 52, the mid spacer 56 and the bottom spacer 60 are preferably formed from polyamide. The first and second sealing members 54,58 are preferable formed from elastomer. The sealing members 54,58 are sized to fit tightly within the seal chamber 40 and tightly around the male member 16. The sealing members 54,58 are secured axially in the seal chamber 40 by the top spacer 52 and the first conical shoulder 48. The top spacer 52 has a radially enlarged end 62 and an annular surface 64 which seats against the end of the female housing 12 defining the entrance 38, to position the top spacer 52 within the bore 36.

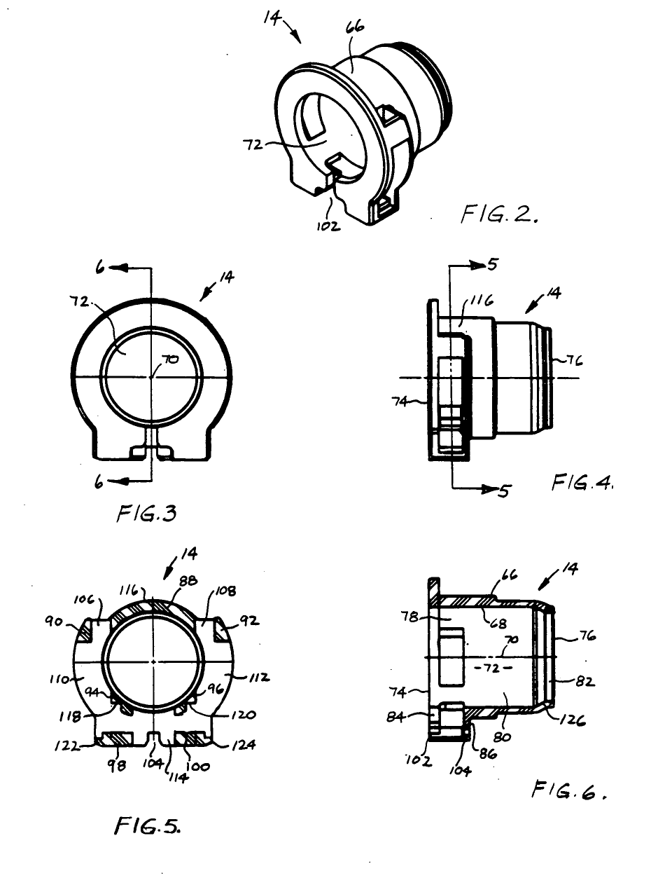

The connector body 14 is illustrated in detail in FIGS. 2-6. The connector body 14 is defined by a generally cylindrical, stepped exterior wall 66 and a generally cylindrical, stepped interior wall 68. The connector body is preferably made of a plastic material, such as polyamide. The interior wall 68 defines a through bore 72. The bore 72 extends completely through the connector body 14, from a larger diameter male member reception end 74 to a smaller diameter retaining end 76. The connector body 14 and the bore 72 is centered about an axis 70.

The connector body 14 is divided into three sections. Moving axially inward from the male member reception end 74 to the retaining end 76, they are: retainer housing section 78, sleeve section 80, and reduced diameter ring section 82.

The retainer housing section 78 is adjacent to the male member reception end 74. It is defined by a C-shaped outer rim 84 connected to an inner rim 86 by a top support member 88, two side support members 90,92, two center support members 94,96 and two bottom support members 98,100. An outer rim slot 102 is defined at the bottom of the outer rim 84. A notch 104 is defined at the bottom of the inner rim 86. The spaces between the top support member 88 and the two side support members 90,92 define two top slots 106,108. The spaces between the two side support members 90,92 and the bottom support members 98,100 define two side slots 110,112. The space between the two bottom support members 98,100 defines a bottom slot 114. The top slots 106,108 receive and position the primary retainer 18 transversely to the axis 70 of the connector body 14. The side slots 110,112 and the bottom slot 114 receive and position the secondary latch/verifier 20 transversely to axis 70 of the connector body 14. The top support member 88 defines a curved upper surface 116. Each of the center support members 94,96 defines a locking shoulder 118,120. A locking ridge 122,124 extends laterally from the outer edge of each bottom support member 98,100.

The sleeve section 80 is located axially inward of the retainer housing section 78. The sleeve section 80 is located radially outward and surrounds the portion of the female housing 12 defining the seal chamber 40. A conical shoulder 126 is situated axially between the sleeve section 80 and the ring section 82. The inner diameter of the sleeve section 80 is slightly larger than the diameter of the exterior wall 30 of the portion of the female housing 12 defining the seal chamber 40; thus allowing the connector body 14 to be slidably mounted on the female housing 12. Likewise, the inner diameter of the ring section 82 is slightly larger than the diameter of the exterior wall 30 of the portion of the female housing 12 defining the tube end receptacle 42.

As illustrated in FIG. 1, the male member 16 is formed at the end of the second tube 24. The second tube 24 and hence the male member 16 is preferably formed from a metallic material, although the second tube 24 and the male member 16 can also be formed from a polymeric material. The second tube 24 is preferably attached to an omega shape flexible member (not shown), similar to the flexible member 26 attached to the first tube 22. The flexible member allows the male member 16 to be more easily aligned with the female housing 12. The male member 16 includes a radially enlarged upset 128 formed a given distance from an open tube end 130. The tube end 130 can be rounded or tapered to make insertion of the male member 16 into the connector body 14 and female housing 12 less difficult. A smooth, cylindrical sealing surface 132 extends between the upset 128 and the tube end 130. The outer diameter of sealing surface 132 should be such that the end of male member 16 fits snugly within the tube end receptacle 42 of the female housing 12.

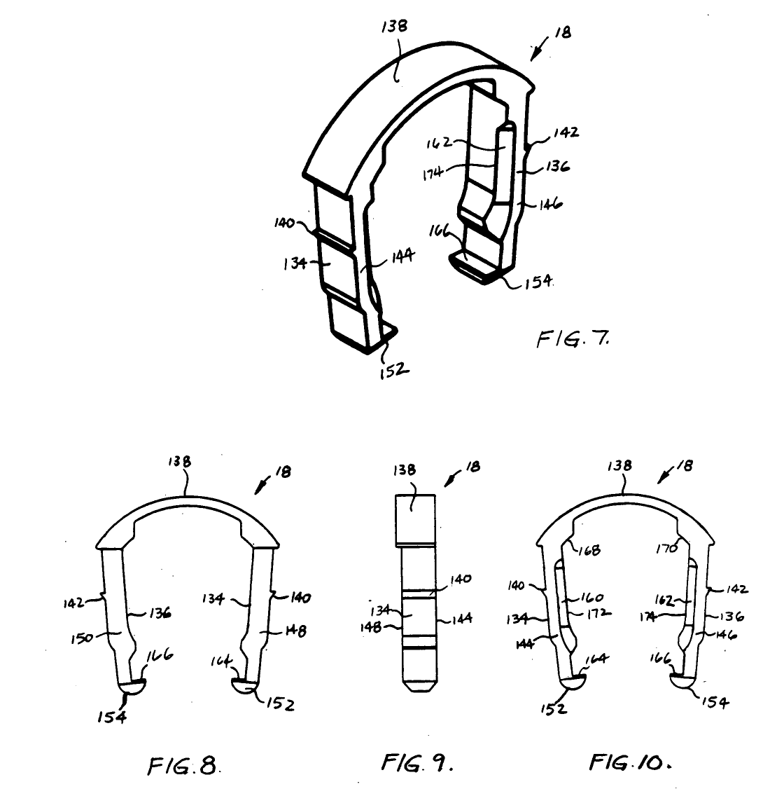

The “horse-shoe” type primary retainer 18 is illustrated in detail in FIGS. 7-10. It is preferably made of a resilient, flexible material, such as plastic. The primary retainer 18, which extends through the top slots 106,108 of the retainer housing section 78, is demountably coupled to the connector body 14.

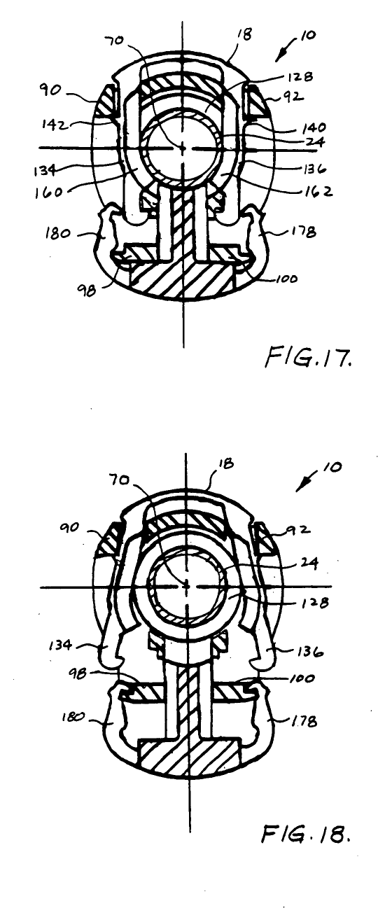

The primary retainer 18 includes a pair of elongated, generally parallel legs 134,136 extending from, and joined at one end by, a cross member 138. The cross member 138 provides a separation between the legs 134,136 approximately equal to the non-upset outer diameter of the male member 16. The legs 134,136 have an axial width approximately equal to, but slightly less than (to allow clearance), the axial width of the top slots 106,108. The lateral width of the legs 134,136 is significantly less than the lateral width of the top slots 106,108, in order to allow outward expansion of the legs 134,136 (to permit male member insertion and release). Each leg 134,136 includes a barb 140,142 extending laterally outward from the laterally outer surface of the leg. Each barb 140,142 is adapted to abut the corresponding side support member 90,92 (as shown in FIG. 17) to prevent unintentional radially outward movement of the primary retainer 18.

The cross member 138 has an axial width greater than that of the legs 136. As illustrated in FIG. 9, the cross member 138 is axially aligned with the rear faces 144,146 of the legs 134,136, but extends axially beyond the front faces 148,150 of the legs 134,136.

Each leg 134,136 includes a latch 152,154 formed at an end remote from the cross member 138 and a sloping lead area 160,162 formed on the rear face 144,146 between the latch 152,154 and the cross member 138. When the primary retainer 18 is fully inserted into the connector body 14, the latches 152,154 lock the primary retainer 18 into position relative to the connector body 14. Latching edges 164,166, defined by the latches 152,154, engage the locking shoulders 118,120, defined by the center support members 94,96 of the connector body 14, to lock the primary retainer 18 in place. At the same time, the barbs 140,142 defined on the laterally outer surfaces of the legs 134,136 are situated immediately below the side support members 90,92 in abutting relationship with the side support members to prevent unintentional radially outward movement of the primary retainer 18.

Ramped or camming surfaces 168,170 are formed on the laterally inner surface of each leg 134,136, just below the cross member 138. When assembled, the ramped surfaces 168,170 rest just above the curved upper surface 116 of the top support member 88 of the connector body 14. If pressure is applied to the cross member 138 to press the primary retainer 18 further into the connector body 14, the ramped surfaces 168,170 contact and slide or cam against the top support member 88. Consequently, the legs 134,136 spread apart, allowing release of the male member 16.

The lead areas 160,162 slope radially and axially inward from the rear face 144,146 of each leg 134,136, and terminate between the rear face 144,146 and the front face 148,150. The spacing between the lead areas 160,162 is at its greatest adjacent the rear face 144,146. Here, the spacing is approximately equal to the diameter of the upset 128 formed on the male member 16. At the front edges 172,174 of the lead areas 160,170, the spacing between the lead areas 160,162 is approximately equal to the (non-upset) outer diameter of the male member 16. The portions of the lead areas 160,162 closer to the latches 152,154 curve inwardly to match the annular profile of the male member upset 128. This assists in guidance and centering of the male member 16 through the connector body 14.

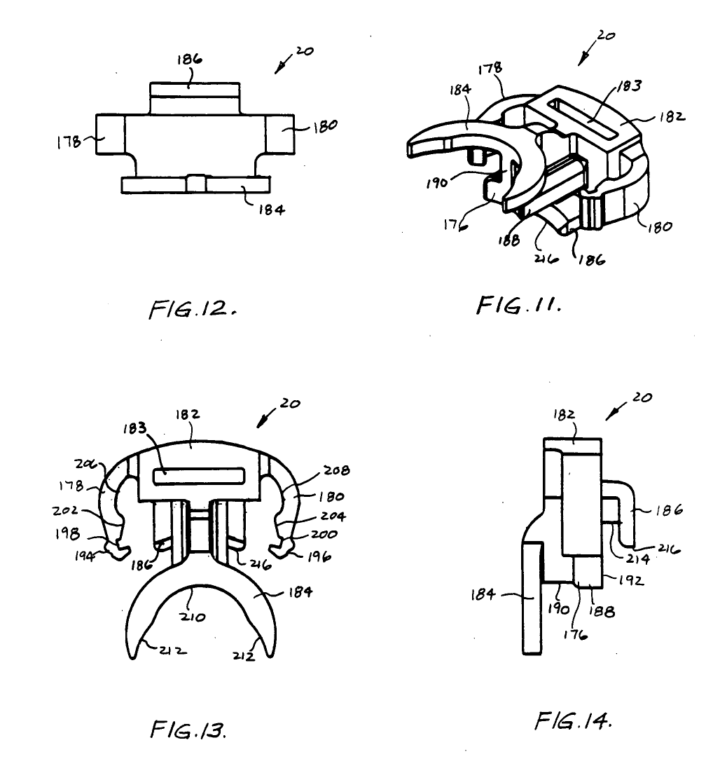

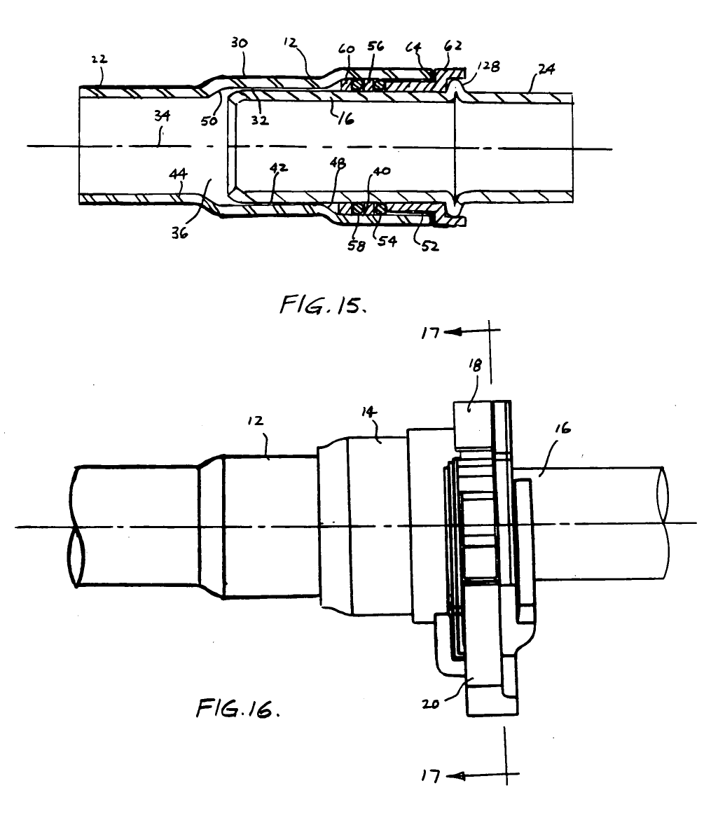

The secondary latch/verifier 20 is illustrated in detail in FIGS. 11-14. It is preferably made of a resilient, flexible material, such as plastic. The secondary latch/verifier 20 includes a retainer beam 176, and a pair of elongated, generally parallel fingers 178,180 joined by a connecting member 182. Extending axially from the rear of the retainer beam 176 is a tube verifier 184. The connector member 182 defines a rectangular shaped notch 183. The notch 183 is shaped to allow a knifed edge having a rectangular shaped cross-section, such as the end of a screw driver, to be inserted therein to provide the leverage necessary to pry the secondary latch/verifier 18 from a latched position (as illustrated in FIGS. 16 and 17) to a non-latched position. Extending axially from the front of the connecting member 182 is a retaining rim 186.

The retainer beam 176 includes a laterally enlarged portion 188 and a narrowed portion 190. The lateral width of the enlarged portion 188 is slightly less than the lateral width of the bottom slot 114. The lateral width of the narrowed portion 190 is slightly less than the lateral width of the outer rim slot 102. The enlarged portion 188 defines an abutment surface 192 for abutment with the upset 128 of the male member 16. The radially inner surface of the retainer beam 176 is curved to match the curvature of the outer surface of the tube 24 forming the male member 16.

Each finger 178,180 includes a hook 194,196 formed at an end remote from the connecting member 182. Notches 198,200, defined by the hooks 194,196, engage the locking ridges 122,124, defined by the bottom support members 98,100 to secure the secondary latch/verifier 20 to the connector body 14 when the secondary latch/verifier is in an unlatched positioned. Located between the hooks 194,196 and the connecting member 182, the inner surface of each finger 178,180 defines a ramped surface 202,204 and a laterally enlarged surface 206,208. The lateral distance between the ramped surfaces 202,204 of the two fingers 178,180 is smaller than the lateral distance between the locking ridges 122,124. The lateral distance between the laterally enlarged surfaces 206,208 of the two fingers 178,180 is approximately equal to the lateral distance between the locking ridges 122,124. Furthermore, the narrowest lateral distance between the inner surfaces of the fingers 178,180 is slightly greater than the lateral distance between the outer surfaces of the legs 134,136 of the primary retainer 18. The axial width of the fingers 178,180 is approximately equal to the axial width of the legs 134,136.

The tube verifier 184 is generally moon shaped. The radially inner surface of the tube verifier 184 has a first curved surface 210 and a second curved surface 212. The first curved surface 210 is curved to match to curvature of the outer surface of the tube 24 forming the male member 16. The second curved surface 212 is curved to match the curvature of the outer surface of the upset 128.

The retaining rim 186 extends axially from the front of the connecting member 182. A rib 214 connects the rear surface of the retaining rim 186 to the front surface of the connecting member 182. The lateral width of the rib 214 is slightly smaller than the lateral width of the notch 104 of the inner rim 86. The axial length of the rib 214 is slight larger than the axial thickness of the inner rim 86. An edge 216 is defined at the radially inward edge of the retaining rim 186. The curvature of the edge 216 matches the curvature of the portion of the exterior wall 30 surrounding the seal chamber 40.

To assemble the quick connector coupling 10 according to the present invention, the primary retainer 18 is first attached to the connector body 14. The legs 134,136 of the primary retainer 18 are inserted through the top slots 106,108 of the retainer housing section 78. The primary retainer 18 is oriented such that the cross member 138 and the ramped surfaces 168,170 are located above the top support member 88, and the lead areas 160,162 of the legs 134,136 face the male member reception end 74.

Insertion of the legs 134,136 through the top slots 106,108 is facilitated by applying a downward force on the cross member 138. “Downward force,” as defined in this patent application, is a force that is applied toward the connector body 14. An increase in downward force is necessary when the legs 134,136 contact the sides of center support members 94,96. Applying sufficient downward force, the rounded ends of the legs 134,136 slide against the sides of the center support members 94,96, spreading the legs 134,136 apart and allowing the legs 134,136 to pass by the center support members 94,96. When the legs clear the center support members 94,96, the legs 134,136 spring laterally inward with the latching edges 164,166 positioned under the locking shoulders 118,120 of the center support members 94,96 to secure the primary retainer 18 to the connector body 14. At the same time, the barbs 140,142 defined on the laterally outer surfaces of the legs 134,136 are situated immediately below the side support members 90,92 in abutting relationship with the side support members to prevent unintentional radially outward movement of the primary retainer 18. A properly attached primary retainer 16 is illustrated in FIGS. 16 and 17. In the attached position, the legs 134,136 of the primary retainer 18 are approximately perpendicular to the axis 70 of the bore 72 when viewed from the side (see FIGS. 1 and 16). When viewed from the front or the rear, the legs 134,136 are approximately equally spaced from the axis 70 of the bore 72 (see FIG. 17).

The connector body 14 is mounted to the first hollow tube 22 prior to the attachment of the flexible member 26 to the tube 22. With the primary retainer 18 properly attached to the connector body 14, the connector body 14 is then positioned radially outward of the female housing 12. The connector body 14, slidably mounted to the tube 22, is slid in the rearward axial direction, towards the entrance 38 of the female housing 12. Resistance to rearward axial movement occurs when the legs 134,136 of the primary retainer 18 contact the exterior wall 30 radially outward of the first conical shoulder 48 of the female housing 12. As the connector body 14 is slid further in the rearward axial direction, the legs 134,136 ride along the exterior wall 30, radially outward of the first conical shoulder 48, causing the legs 134,136 to flex laterally outward. The legs 134,136 spring back into place behind the top spacer 52 once the legs 134,136 have passed the exterior wall 30, radially outward of the first conical shoulder 48 and the seal chamber 40, and the top spacer 52. In this position, forward axial movement is limited by the legs 134,136 abutting the top spacer 52. Rearward axial movement is limited by the conical shoulder 126 of the connector body 14 abutting the exterior wall 30, radially outward of the first conical shoulder 48, of the female housing 12.

Once the connection body 14 is positioned radially outward of the female housing 12, the male member 16 is then inserted into the connector body 14 and the female housing 12. The sealing surface 132 of the male member 16 passes between legs 134,136 of the primary retainer 18 and into the seal chamber 40 of the female housing 12 with little or no resistance, as the spacing between the legs 134,136 is approximately equal to the non-upset outer diameter of the male member 16. Resistance to insertion occurs when the upset 128 of the male member 16 contacts the legs 134,136. The lead areas 160,162 of the legs 134,136 permit passage of the upset 128 between the legs upon applying sufficient axial inward force. As the upset 128 passes between legs 134,136, it rides along the lead areas 160,162 and flexes the legs 134,136 laterally outward. Once the upset 128 has passed the legs and into the radially enlarged end of the top spacer, the legs 134,136 spring back into place behind the upset 128 to a locked position. As the legs 134,136 spring back into place, they produce an audible click providing verification that the legs are in the locked position. The front faces 148,150 of the legs 134,136 abut the upset 128 to prevent subsequent withdrawal of the male member 16 from the connector body 14. At the same time, the sealing surface 132 of the male member 16 is situated in the seal chamber 40 and the tube end receptacle 42 of the female housing 12, such that the sealing surface 132 deforms the first sealing member and 54 and the second sealing member 58 to create a fluid/vapr seal between the sealing surface 132 and the seal chamber 40. The top spacer 52, along with the first conical shoulder 48 defined on the interior wall 32 of the connector body 14, prevents further inward insertion of male member 16 from the locked position.

Alternatively, the male member 16 can be first inserted into the female housing 12 and then the connector body 14 is slid in the rearward axial direction until the legs 134,136 are in a locked position. For the alternative installation procedure, the male 16 is inserted into the seal chamber 40 and the tube end receptacle 42 of the female housing until the upset 128 is situated in the radially enlarged end 62 of the top spacer 52 as illustrated in FIG. 15. Thereafter, the connector body 14 is slid in the rearward axial direction. Resistance to rearward axial movement occurs when the legs 134,136 of the primary retainer 18 contact the exterior wall 30 radially outward of the first conical shoulder 48 of the female housing 12. As the connector body 14 is slid further in the rearward axial direction, the legs 134,136 ride along the exterior wall 30, radially outward of the first conical shoulder 48, causing the legs 134,136 to flex laterally outward. The legs 134,136 spring back into place behind the top spacer 52 once the legs 134,136 have passed the exterior wall 30, radially outward of the first conical shoulder 48 and the seal chamber 40, and the top spacer. As the legs 134,136 spring back into place, an audible click is produced to provide verification that the legs 134,136 are in the locked position.

It should be noted that one advantage the coupling 10 of the present invention has over some prior art couplings is that the connector body 14 is not part of the fluid line system. This allows the connector body to be formed of non-conductive material without having any undesirable electrostatic discharge (ESD) concerns associated with using such non-conductive material. The fluid line of the coupling 10 is directly linked by the insertion of the metallic male member 16 into the metallic female housing 12. Any electrostatic accumulated in one of the metal tubes 22,24 is easily able to travel to ground by arcing across the short distance between the metallic male member 16 and the metallic female housing 12. Since the electrical path does not travel through the connector body 14, the connector body can be formed of any material. This allows the connector body 14 to be formed of a polymeric material without having to add expensive conductive fillers, such as metallic fibers, carbon black or carbon fibers. Another advantage the coupling 10 of the present invention has over some prior art couplings is that the connector body 14 is rotationally independent of the remainder of the coupling for the connector body 14 to operate properly. In other words, the connector body can be spun any where within a 360° rotation and still operate properly. This ability for the connector body 14 to operate rotationally independent allows to easy installation of the coupling 10 (by not having to rotationally align the connector body 10).

Release of the male member 16 from a locked position can be achieved by exerting a downward force on the cross member 138. Downward force on the cross member 138 causes the ramped surfaces 168,170 to contact the curved upper surface 116 of the top support member 88 of connector body 14. The ramped surfaces 168,170 slide or cam against the top support member 88, causing the legs 134,136 to spread apart laterally as application of downward force continues. Eventually, the legs 134,136 will be spread apart a distance sufficient to allow passage of the upset 128 between the legs 134,136. The male member 16 may then be withdrawn from the connector body 14 and the female housing 12. Upon withdrawal of the male member 16 from the connector body 14 and relaxation of primary retainer 18, the primary retainer 18 reassumes to its normal installed position.

The coupling is completed by positioning the secondary latch/verifier 20 from a non-latched position, in which the locking ridges 122,124 are located within the notches 198,200 to a latched position (as illustrated by FIGS. 16 and 17). To position the secondary latch/verifier 20 to the latched position, a downward force is applied to the connecting member 182. With sufficient downward force, the ramped surfaces 202,204 of the fingers 178,180 slide against the sides of the locking ridges 122,124, spreading the fingers 178,180 apart and allowing the fingers to pass by the bottom support members 98,100. With the male member 16 properly inserted in the connector body 14 and the female housing 12, as illustrated in FIGS. 16 and 17, the secondary latch/verifier 20 is able to move to a position where a section of the fingers 178,180 of the secondary latch/verifier 20 are located laterally outward of the legs 134,136 of the primary retainer 18. At the same time, the retainer beam 176 and the tube verifier 184 are moved radially inward toward the male member 16, and the retaining rim 186 is moved radially inward toward the exterior wall 66 of the connector body 14.

When the secondary latch/verifier 20 is fully inserted into the connector body 14, the locking ridges 122,124 surpass the ramped surfaces 202,204 of the fingers 178,180 and are situated between the laterally enlarged surfaces 206,208. The fingers 178,180 of the secondary latch/verifier 20 spring laterally inward to the latched position as illustrated in FIG. 17. The fingers 178,180 of the secondary latch/verifier 20 are approximately perpendicular to the axis 70 of the bore 72 when viewed from the side (see FIGS. 1 and 16). When viewed from the front or the rear, the fingers 178,180 are approximately equally spaced from the axis 70 of the bore 72 (see FIG. 17). In the latched position, a portion of each finger 178,180 of the secondary latch/verifier 20 is positioned laterally outward of the corresponding leg 134,136 of the primary retainer 18. The position of the fingers 178,180 relative to the legs 134,136 prevents the legs 134,136 from moving laterally outward to release the male member 16 from the locked position. In the latched position, the rear surface of the retainer beam 176 is in axial abutting relationship with the upset 128 of the male member 16. This axial abutting relationship between the retainer beam 176 and the upset 128 provides the secondary latch/verifier 20 with the secondary latch feature to retain the male member 16 in the connector body 14 should the primary retainer 18 fail.

The retaining rim 186 and the tube verifier 184 serve to position the secondary latch/verifier 20 to the connector body 14. In the latched position, the rib 214 extends through the notch 104 defined on the bottom of the inner rim 86. The retaining rim 186 is situated immediately axially forward of the inner rim 86 of the connector body 14 and immediately radially outward of the exterior wall 66 of the connector body 14. The connecting member 182 is situated immediately axially rearward of the inner rim 86. The retaining rim 186 and the connecting member 182 of the secondary latch/verifier 20 sandwich the inner rim 86 to axially position the secondary latch/verifier 20 relative to the connector body 14. The narrowed portion 190 of the retainer beam 176 extends through the outer rim slot 102. The tube verifier 184 is situated immediately rearward of the outer rim 84 of the connector body 14 and immediately radially outward of the tube 24 forming the male member 16. Since the retaining rim 186 is situated immediately radially outward of the connector body 14 and the tube verifier 184 is also situated immediately radially outward of the tube 24, the retaining rim 186 and the tube verifier 184 prevents the secondary latch/verifier 20 from tilting once it is in the latched position.

FIG. 18 illustrates a situation when the male member 16 was not properly inserted into the connector body 14. In such a situation, the male member 16 has not been sufficiently inserted into the connector body 14 for the upset 128 to surpass the legs 134,136 of the primary retainer 18. With the legs 134,136 still spread apart, the fingers 178,180 of the secondary latch/verifier 20 are unable to be inserted radially inward into the connector body 14 since the ends of the fingers 178,180 will abut the still spread apart legs 134,136 of the primary retainer 18. Furthermore, with the male member 16 insufficiently inserted into the connector body 14, the upset 128 is located immediately radially inward of the retainer beam 176 of the secondary latch/verifier 20. Abutment of the radially inward surface of the retainer beam 176 with the radially outer surface of the upset 128 also prevents the secondary latch/verifier from being able to be inserted radially inward into the connector body 14. This inability of the secondary latch/verifier 20 from moving radially inward to the latched position provides verification to the user that the male member 16 has not been sufficiently inserted into the connector body 14. On the other hand, if the male member 16 has been sufficiently inserted into the connector body 14, such that the upset 128 has surpassed the legs 134,136 of the primary retainer 18, the ends of the fingers 178,180 of the secondary latch/verifier 20 will not abut the legs 134,136 of the primary retainer 18 and the radially inward surface of the retainer beam 176 will not abut the radially outer surface of the upset 128 allowing the secondary latch/verifier 20 to move to the latched position. This ability of the secondary latch/verifier 20 to move radially inward to the latched position provides verification to the user that the male member 16 has been sufficiently inserted into connector body 14.

Various features of the present invention have been explained with reference to the embodiment shown and described. It must be understood, however, that modification may be made without departing from the spirit of the invention and scope of the following claims.

1. A quick connector coupling for forming a joint in a fluid/vapor line system comprising:
a female housing having a bore extending from an end of said female housing and a radially enlarged section;
a connector body having slots formed therethrough, and a through bore extending from an end of said connector body, a portion of said connector body located radially outward of said radially enlarged section of said female housing;
a male member extending through said ends of said connector body and female housing and into said female housing bore, said male member having a tubular surface and an annular upset, said upset having a diameter greater than the diameter of said tubular surface;
a retainer coupled to said connector body, said retainer including a cross member and two spaced legs extending from said cross member and through said slots, said legs in abutting relationship with said male member upset, said legs in a locked position in which said legs are spaced apart a distance less than the diameter of said upset.

2. The coupling as claimed in claim 1 wherein said connector body is formed from a polymeric material.

3. The coupling as claimed in claim 2 wherein said connector body is formed from polyamide.

4. The coupling as claimed in claim 2 wherein said male member and said female housing is formed from a metallic material.

5. The coupling as claimed in claim 1 further comprising a sealing member located radially between said male member and said female housing.

6. The coupling as claimed in claim 5 wherein said sealing member is situated within said radially enlarged section of said female housing.

7. The coupling as claimed in claim 5 wherein said sealing member is formed from elastomer.

8. The coupling as claimed in claim 5 further comprising a second sealing member located radially between said male member and said female housing.

9. The coupling as claimed in claim 1 further comprising a spacer having a first section and a radially enlarged second section, said first section inserted into said female housing, said upset of said male member located radially inward of the said second section.

10. The coupling as claimed in claim 9 wherein said spacer is formed from polyamide.

11. The coupling as claimed in claim 1 further comprising a secondary latch/verifier coupled to the connector body, the secondary latch/verifier includes two fingers positioned approximately perpendicular to the bore, each finger has a portion positioned laterally outward of one of the legs.

12. The coupling as claimed in claim 11 wherein said fingers are able to be positioned laterally outward of said legs only if the legs are in the locked position.

13. The coupling as claimed in claim 11 wherein said secondary latch/verifier further includes a beam in axial abutting relationship with said male member upset.

14. The coupling as claimed in claim 13 wherein the radially inner surface of said beam abuts the radially outer surface of said upset if the male member has not been sufficiently inserted into the connector body.

15. The coupling as claimed in claim 13 wherein said beam is movable to the axial abutting relationship with said male member upset only if the male member has been sufficiently inserted into the connector body.

16. The coupling as claimed in claim 11 wherein said secondary latch/verifier further includes a rim, said rim axially positions said secondary latch/verifier relative to said connector body.

17. The coupling as claimed in claim 11 wherein said legs movable from said locked position to a released position in which said legs are spaced apart a distance greater than said upset diameter if the fingers of said secondary latch/verifier are not positioned laterally outward of said legs.

18. A coupling as claimed in claim 17 wherein said primary retainer further includes a release being cooperable with said connector body to move said retainer beams from said locked position to said release position.

19. The coupling as claimed in claim 11 wherein said fingers prevent said legs from moving from said locked position to a released position in which said legs are spaced apart a distance greater than said upset.

20. The coupling as claimed in claim 1 wherein said female housing is formed from one end of a first hollow tube, said male member is formed one end of a second hollow tube.

21. The coupling as claimed in claim 20 wherein said first hollow tube and said second hollow tube are metallic.

22. The coupling as claimed in claim 20 further comprising a flexible member attached to other end of said first hollow tube.

23. The coupling as claimed in claim 20 further comprising a flexible member attached to other end of said second hollow tube.

24. The coupling as claimed in claim 1 wherein said connector body has a conical surface, said conical surface abuts said female housing.

25. A quick connector coupling for forming a joint in a fluid/vapor line system comprising:
a metallic female housing having a bore extending from an end of said female housing and a radially enlarged section;
a polymeric connector body;
a metallic male member extending through said end of said female housing and into said female housing bore, said male member having a tubular surface and an annular upset, said upset having a diameter greater than the diameter of said tubular surface;
a retainer coupled to said connector body, said retainer in abutting relationship with said male member upset preventing said male from moving out of the female housing.

26. The coupling as claimed in claim 21 wherein said connector body has a conical surface, said conical surface abuts said female housing.
